(19) United States
(12) Patent Application Publication
(10) Pub. No.: US 2005/0072021 A1
(43) Pub. Date: Apr. 7, 2005

(54) Method for drying layers of organic semiconductors, conductors or color filters using ir and nir radiation

(76) Inventors: Jurgen Steiger, Frankfurt (DE); Susanne Heun, Bad Soden (DE); Hort Vestweber, Gilserberg-Winterscheid (DE); Manfred Wiener, Hofheim (DE); Andreas Matthaus, Sulzbach (DE)

Correspondence Address: CONNOLLY BOVE LODGE & HUTZ, LLP, P O BOX 2207, WILMINGTON, DE, 19899, US

(21) Appl. No.: 10/493,814

(22) PCT Filed: Oct. 25, 2002
(86) PCT No.: PCT/EP02/11941

(30) Foreign Application Priority Data
Oct. 30, 2001 (DE) 101 53 445.0

(51) Int. Cl. F26B 3/34

(52) U.S. Cl. 34/275

(57) ABSTRACT

The invention relates to a method for drying and/or subsequently treating thin layers containing organic semiconductors, organic conductors or organic colour filters. The method is used in the production of organic light emitting diodes (PLED's), organic integrated circuits (O-IC's), organic field effect transistors (OFET's), organic thin-film transistors (OTFT's), organic solar cells (O-SC's), organic laser diodes (O-lasers), organic colour filters for liquid crystal displays or organic photoreceptors.

Method for drying layers of organic semiconductors, conductors or colour filters using IR and/or NIR radiation

The present invention relates to a method for drying layers of organic semiconductors, organic colour filters or organic conductors and the layers of these organic semiconductors, organic colour filters or organic conductors thereby produced.

In a number of different applications, which in the broadest sense can be classified in the electronics industry, the use of organic semiconductors, organic colour filters or organic conductors as active components (=functional materials) has long been a reality or is expected in the near future.

Charge-transport materials on an organic base (as a rule, hole transporters based on triarylamine) have been used for some years in copiers. The use of special semiconducting organic compounds, some of which are also capable of emitting light in the visible spectral region, is just on the point of being introduced onto the market, for example in organic and polymeric electroluminescence devices.

The use of organic charge-transport layers in applications such as organic integrated circuits (organic ICs) and organic solar cells has already shown very good progress at least in the research stage, so that introduction onto the market can be expected in the next few years.

The number of further possibilities is very great, but they are often to be regarded solely as a modification of the aforementioned processes, as the examples of the organic solid laser diodes and organic photodetectors demonstrate.

With some of these modern applications, the development is in part already very far advanced, but there is still a huge demand—depending on the application—for technical improvements.

As a rule, all these devices make use of thin layers of organic semiconductors or organic conductors.

Thin layer means here that the layer thicknesses lie in the range from 10 nm to 10 μm, but usually smaller than 1 μm.

A widespread process for the production of these thin layers is the deposition of solutions or dispersions of suitable organic semiconductors or organic conductors.

This deposition can take place in a variety of ways:
typical simple coating methods are suitable, such as for example squeegee, spin-coating, meniscus coating, dip coating, airbrush coating (spray coating) and other methods modified therefrom.
various methods are in principle suitable as higher-resolution deposition methods, such as for example offset printing, inkjet printing (IJP), transfer printing, screen-printing and other printing methods not explicitly mentioned here.

All these methods have the following in common: solutions or dispersions of the respective organic semiconductor compounds or organic conductor compounds are used. As a rule, the concentration of the active component is relatively small and usually amounts to between 0.01 and 20 wt. %.

This means that, after the deposition, the wet film thickness is many times greater (often more than 100 times) than the solid film thickness of the dried wet film. It is of great importance, therefore, to use an efficient, reproducible process when drying, which also leads to all of the solvent being removed.

As a rule, this extremely important process has not hitherto been taken into account at all. The solutions or dispersions were deposited, they were then left for a while, after which further process steps then followed. When high-boiling solvents (e.g. tetralin, boiling point 206° C., dodecyl benzene, boiling point >300° C.) or also difficultly volatile ones (such as water, for example) were used, a heat-treatment process, partially in a vacuum, was often proposed or carried out.

For the aforementioned high-boiling solvents, therefore, it is reported in EP-A-1 083775, for example, that the drying is carried out in the range from 100 to 200° C., partially under an under-pressure (2 mbar) and in a nitrogen atmosphere respectively for 1 to 10 minutes. In the patent application cited here, layers of organic semiconductors for use in PLEDs (polymer LEDs) are described, which are produced by IJP.

EP-A-991303 reports for example that films of organic conductors (here: PEDOT, a poly-thiophene derivative, which is obtainable commercially in aqueous dispersion from Bayer AG, Leverkusen, under the name BAYTRON-P™) are dried by the fact that they are heat-treated for 5 minutes at 110° C.

These examples demonstrate that the drying of suitable thin films is relatively expensive and laborious. It is important to note here that complete removal of the respective solvent is often of decisive importance for the respective application (see also example 1).

The drawback with the above-mentioned methods, which are generally used today for drying thin layers of organic semiconductors, organic colour filters or organic conductors, is as follows:
Although a heat supply via a heating plate is easy to carry out in a laboratory operation, it gives rise to considerable problems in an industrial process.
Vacuum processes are always time-intensive and expensive. For industrial processes, therefore, an attempt is made to limit their use as far as possible.
An extremely important point is the time requirement. Most processes for the mass production of suitable devices can only be operated on an economical basis if the total process time lies in the range of a few minutes. If, in one step alone (as a rule, one of very many steps), several minutes are required here solely for the drying, this can lead to the whole technology becoming unusable.

There is therefore a clear need to develop improved methods for drying suitable layers. German utility model specification DE 20020604 U1 proposes a device for the drying of such or similar layers, which essentially consists in the application of IR or NIR (IR=infrared, i.e. light with a wavelength of more than 700 nm; NIR=near IR, i.e. light with a wavelength in the range from approx. 700 to 2000 nm and an energy in the range from approx. 0.6 to 1.75 eV). It is described how a suitable IR or NIR source is integrated as directly as possible into the coating apparatus. Furthermore, the possibility of an additive gas flow is also discussed.

In this utility model specification, however, there are no practical pointers to the actual use. Thus, no information is given concerning the time requirement. Nor is it possible, unfortunately, to derive any further details. The information stated in the specification to the effect that a quartz lamp is used at raised temperature can even lead to huge problems in the application. If the lamp radiates large quantities of visible light or UV light in addition to the IR or NIR portion, this can severely damage the respective layers, especially when the action takes place under normal atmosphere or over a lengthy period (see for example Synth. Met. 2000, 111-112, 553-557). The device described here, therefore, has only a limited suitability for bringing about a corresponding improvement.

Surprisingly, however, it has been found that very good drying behaviour can be achieved if the wet film of an organic semiconductor or organic conductor is treated with suitable IR or NIR radiation after being coated or deposited on a substrate. Complete drying of the wet film can be brought about in this way in less than 60 seconds, usually less than 30 seconds, often even less than 10 seconds, in many cases less than 1 second, in some cases less than 0.1 seconds.

Complete drying means here that there is contained in the finished solid film layer less than 1% (related to the mass), preferably less than 0.1%, particularly preferably less than 10 ppm, very particularly preferably less than 1 ppm of solvent.

The following is important for good film formation and the avoidance of unfavourable effects during drying:
The delivered radiant flux per unit area must be high enough to achieve really complete drying in the stated short time, preferably greater than 75 kW/m². Smaller radiation intensities lead to a longer drying time.
The least possible visible light (i.e. light with wavelengths in the range from 400 to 700 nm) or UV light (i.e. light with wavelengths less than 400 nm) should be emitted. According to the invention, radiation is used whereby at least 80% of the radiant energy is delivered in the range from 700 to 2000 nm, particularly preferably if this is more than 95%, very particularly preferably if this is more than 99%. If suitable lamps or IR supply devices do not permit this, there is of course also a possibility of removing the shorter wavelengths by means of a suitable filter.

The subject-matter of the invention, therefore, is a method for producing thin layers of organic semiconductors, organic conductors or organic colour filters, comprising the steps:
(a) deposition of solutions or dispersions containing at least one organic semiconductor or organic conductor or organic colour filter on a substrate,
(b) drying of the wet film produced according to step (a) by means of IR and/or NIR radiation,
   characterised in that, in step (b), radiation is used with which at least 80% of the radiant energy lies in the range from 700 to 2000 nm.

The deposition of the solution or dispersion in step (a) can take place with any method. Examples thereof are spin-coating, squeegee, meniscus coating, dip coating, airbrush coating, but also offset printing, inkjet printing, transfer printing or screen-printing and also other methods not explicitly mentioned here.

It is preferable for the corresponding radiation effect to be less than 60 seconds, preferably less than 30 seconds, particularly preferably less than 10 seconds, very particularly preferably less than 1 second, above all very particularly preferably less than 0.1 seconds, whereby however complete drying is nonetheless achieved.

Furthermore, therefore, it is preferable for the corresponding irradiation to be applied with an intensity of more than 75 kW/m², preferably of more than 150 kW/m², particularly preferably of more than 300 kW/m².

As explained above, it is further preferable for at least 95%, particularly preferably at least 99%, of the radiant energy to be introduced into the wet film layer by light with a wavelength of the range from 700 to 2000 nm.

In a further preferred form of embodiment, IR/NIR radiation is used, the wavelength whereof lies in the range from more than 700 up to 2000 nm, particularly preferably in the range from 800 nm to 1500 nm.

It is further preferable for this drying to take place directly after the coating, the drying device best being incorporated into the coating device.

In a special embodiment of the drying method, it may further be preferable for the drying to take place or to be started already during the coating.

Moreover, it may further be advantageous for other processes accelerating the drying to be employed in addition to the radiation effect. The effect of this can be that the total drying time is reduced still further and also that the film morphology is further improved, without being bound to a special theory in the case of this phenomenon. Possible other methods here are a brief increase in the temperature, rapid exchange of the gas space (e.g. with an inert gas such as nitrogen or argon), or also lowering of the ambient pressure.

The method according to the invention has the following advantages over the aforementioned prior art:

It offers an efficient and rapid option for completely drying the aforementioned layers.
The method proceeds sparingly and delivers very good results for the respective applications (see also examples 3-8).
The method does not cause any damage to the respective films, since potentially damaging light wavelengths are eliminated to a very large extent.

Surprisingly, it has also been found that, as a result of the aftertreatment of layers of organic semiconductors, organic conductors or organic colour filters, which have already been dried conventionally, with IR/NIR radiation in which at least 80% of the radiant energy lies in the range from 700 to 2000 nm, further advantages arise in respect of their application properties. These are described, amongst other things, in example 8 of the present application. This method is also the subject-matter of the present invention.

A further subject-matter of the invention, therefore, is the aftertreatment of layers of organic semiconductors, organic conductors or organic colour filters, which have already been dried conventionally, with IR/NIR radiation in which at least 80% of the radiant energy lies in the range from 700 to 2000 nm.

The terms used here are defined by analogy with the above description. The preferred ranges also apply to the aftertreatment method.

The coatings obtained both by the drying method (see also examples 3-7) as well as the aftertreatment method (see example 8) display marked advantages in respect of their morphology compared with conventionally dried layers, without being bound to a particular theory in the case of this phenomenon. These layers are therefore novel and thus also the subject-matter of the present invention.

The subject-matter of the invention also relates to layers of organic semiconductors, organic colour filters and organic conductors characterised in that they have been dried and/or aftertreated by one of the two methods according to the invention.

The aforementioned layers according to the invention are used in suitable devices, such as for example polymeric organic light-emitting diodes (PLEDs), organic integrated circuits (O-ICs), organic field-effect transistors (OFETs), organic thin-film transistors (OTFTs), organic solar cells (O-SCs), organic laser diodes (O-lasers), organic colour filters for liquid crystal displays or organic photoreceptors. Since the morphology—as described above—displays marked advantages over conventionally dried layers, suitable devices containing layers according to the invention are also a further subject-matter of the present invention.

The subject-matter of the present invention, therefore, relates to polymeric organic light-emitting diodes (PLEDs), organic integrated circuits (O-ICs), organic field-effect transistors (OFETs), organic thin-film transistors (OTFTs), organic solar cells (O-SCs), organic laser diodes (O-lasers) or organic photoreceptors characterised in that they contain layers according to the invention.

The methods according to the invention can be used for the production of a large multiplicity of layers of organic semiconductors, organic colour filters or organic conductors.

Organic Semiconductors are for Example those Described in the Following:

Organic semiconductors within the meaning of this invention are generally organic or also organometallic compounds, which—as a solid or more precisely a concrete layer—exhibit semiconducting properties, i.e. with which the energy gap between the conduction band and the valence band lies between 0.1 and 4 eV.

Organic semiconductors are on the one hand low-molecular organic semiconductors based on triarylamines (Proc. SPIE-Int. Soc. Opt. Eng. 1997, 3148, 306-312), aluminium-tris-(8-hydroxy-quinoline) (Appl. Phys. Lett. 2000, 76(1), 115-117), pentacenes (Science 2000, 287(5455), 1022-1023), oligomers (Opt. Mater. 1999, 12(2/3), 301-305), other condensed aromatic systems (Mater. Res. Soc. Symp. Proc. 2000, 598, BB9.5/1-BB9.5/6) and other compounds, such as are described for example in J. Mater. Chem. 2000, 10(7), 1471-1507 und Handb. Adv. Electron. Photonic Mater.

Devices 2001, 10, 1-51. These can be used alone or also in suitable matrix materials, such as for example polystyrene (PS) or polycarbonate (PC). The low-molecular semiconductors disclosed in the aforementioned places are a component part of the present description by citation.

Furthermore and also preferably, however, polymeric organic or organometallic semiconductors are used.

Polymeric organic semiconductors within the meaning of the present description are understood to be in particular
(i) the substituted poly-p-arylene-vinylenes (PAVs) soluble in organic solvents, disclosed in EP-A-0443861, WO 94/20589, WO 98/27136, EP-A-1025183, WO 99/24526, DE-A-19953806 and EP-A-0964045,
(ii) the substituted poly-fluorenes (PFs) soluble in organic solvents, disclosed in EP-A-0842208, WO 00/22027, WO 00/22026, DE-A-19981010, WO 00/46321, WO 99/54385, WO 00/55927,
(iii) the substituted poly-spirobifluorenes (PSFs) soluble in organic solvents, disclosed in EP-A-0707020, WO 96/17036, WO 97/20877, WO 97/31048, WO 97/39045,
(iv) the substituted poly-paraphenylenes (PPPs) soluble in organic solvents, disclosed in WO 92/18552, WO 95/07955, EP-A-0690086, EP-A-0699699,
(v) the substituted polythiophenes (PTs) soluble in organic solvents, disclosed in EP-A-1028136, WO 95/05937,
(vi) the polypyridines (PPys) soluble in organic solvents, disclosed in T. Yamamoto et al., J. Am. Chem. Soc.1994, 116, 4832.
(vii) the polypyrroles soluble in organic solvents, disclosed in V. Gelling et al., Polym. Prepr. 2000, 41, 1770.
(viii) substituted, soluble copolymers, which have structural units of two or more of the classes (i) to (vii),
(ix) the conjugated polymers soluble in organic solvents, disclosed in Proc. of ICSM '98, Part I & II (in: Synth. Met. 1999, 101+102),
(x) substituted and non-substituted polyvinyl-carbazoles (PVKs), as disclosed for example in R. C. Penwell et al., J. Polym. Sci., Macromol. Rev. 1978, 13, 63-160 and
(xi) substituted and non-substituted triarylamine polymers, such as preferentially those disclosed in JP 2000-072722,
(xii) the polysilanes described by Suzuki et al. in Polym. Adv. Technol. 2000, 11 (8-12), 460-467 and by Hoshino et al. in J. Appl. Phys. 2000, 87(4), 1968-1973.

These polymeric organic semiconductors are a component part of the present invention by citation.

Polymeric organometallic semiconductors are described for example in application document DE 10114477.6 (not laid open for public inspection), e.g. organometallic complexes which are polymerised into polymers.

The polymeric organic semiconductors used according to the invention can—as described above—also be doped and/or used as a blend with one another. Here, doped is intended to mean that one or more low-molecular substances are mixed into the polymer; blends are mixtures of more than one polymer, which do not all necessarily have to exhibit a semiconducting property.

Organic conductors can be described by the fact that the electronic states in the conduction band are only partly occupied with electrons. There will be mention in the following of organic conductors, when the specific conductivity a amounts to at least 10⁻⁸ Scm⁻¹.

For the method according to the invention, the organic semiconductors or organic conductors described above must first be deposited from solution or dispersion onto a substrate.

This solution or dispersion consists for example of the organic semiconductors or organic conductors described above and one or more solvents and optionally further additives.

Examples of Solvents That can be Used are Varied:

For organic conductors or organic semiconductors, use is often made of aromatic solvents, such as substituted benzenes (e.g. toluene, anisole, xylenes), heteroaromatics (such as, for example, pyridine and simple derivatives), ether (such as, for example, dioxan) and other organic solvents.

Solvents especially for solutions of polymeric semiconductors have already been described in various patent applications.
Thus, high-boiling aromatic solvents with a preferred boiling point above 200° C. are in particular proposed in EP-A-1 083775, having the following characteristics: it concerns benzene derivatives which have at least three C-atoms in the side chain or chains. Solvents such as tetralin, cyclohexyl-benzene, dodecylbenzene and suchlike are preferentially mentioned in the stated application.
In analogy thereto, EP-A-1 103590 mentions in general solvents with a vapour pressure (at the temperature of the coating process) of less than 500 Pa (5 mbar), preferably of less than 250 Pa (2.5 mbar), and in addition again describes solvents or solvent mixtures of mainly (highly) substituted aromatics.

In application document DE 10111633.0 (not laid open for public inspection), on the other hand, mention is made of solvent mixtures consisting of at least two different solvents, whereof one boils in the range from 140 to 200° C. Also described here in general are solvent mixtures which mainly contain organic solvents, such as xylenes, substituted xylenes, anisole, substituted anisoles, benzonitrile, substituted benzonitriles, or also heterocyclenes, such as lutidine or morpholine.

It can for example be mixtures of solvents of undermentioned group A with those of group B.

Group A:

o-zylene, 2,6-lutidine, 2-fluor-m-zylene, 3-fluor-o-zylene, 2-chlorbenzotrifluoride, dimethyl formamide, 2-chlor-6-fluortoluene, 2-fluoranisole, anisole, 2,3-dimethylpyrazine, 4-fluoranisole, 3-fluoranisole, 3-trifluormethylanisole, 2-methylanisole, phenetole, 4-methylanisole, 3-methylanisole, 4-fluor-3-methyl-anisole, 2-fluorbenzonitrile, 4-fluor-veratrol, 2,6-dimethylanisole, 3-fluorbenzonitrile, 2,5-dimethylanisole, 2,4-dimethylanisole, benzonitrile, 3,5-dimethylanisole, N,N-dimethylaniline, 1-fluor-3,5-dimethoxy benzene or N-methyl pyrrolidinone.

Group B:

3-fluor-benzotrifluoride, benzotrifluoride, dioxan, trifluormethoxy benzene, 4-fluor-benzotrifluoride, 3-fluor-pyridine, toluene, 2-fluor-toluene, 2-fluor-benzotrifluoride, 3-fluor-toluene, pyridine, 4-fluor-toluene, 2,5-difluor-toluene, 1-chlor-2,4-difluorbenzene, 2-fluor-pyridine, 3-chlorfluorbenzene, 1-chlor-2,5-difluorbenzene, 4-chlorfluorbenzene, chlorbenzene, 2-chlorfluorbenzene, p-xylene or m-xylene.
In application document DE 10135640.4 (likewise not yet laid open for public inspection), analogous solvents to the ones mentioned above are used, but aside from the polymeric semiconductors and the solvents, use is also made of further additives, preferably siloxane-containing additives.

Furthermore, water as a solvent or dispersant also comes into consideration precisely for organic conductors. In addition, other, as a rule strongly polar, organic solvents, such as for example DMF, NMP, glycol and its ether/ester derivatives, DMSO, DMAc, alcohols, carboxylic acids, cresols and suchlike, as well as mixtures thereof, can be used precisely for organic conductors.

The layers according to the invention can be produced by the use of solutions or dispersions containing, for example, the aforementioned solvents or mixtures thereof and containing, for example, the aforementioned organic semiconductors or organic conductors.

Production can—as already mentioned above—take place for example using the following methods:
Spin-coating: this method is described for example for the production of organic semiconductor layers and/or organic conductor layers for use in PLEDs in EP 423283, for use in organic solar cells in Sol. Energy Mater. Sol. Cells 2000, 61(1), 63-72, for use in OFETs in Synth. Met. 1997, 89(3), 193-197, and for further uses in Solid State Technol. 1987, 30(6) 67-71.
Inkjet printing: this method is described for example for the production of organic semiconductor layers and/or organic conductor layers for use in PLEDs in EP-A-880303 and Appl. Phys. Lett. 1998, 73(18), 2561-2563 and for use in organic transistors in Science 2000, 5499, 2123-2125. This method is described for the production of colour filters in the JP 11072614, JP 2000187111 and JP 2001108819.
Screen-printing: this method is described for example for the production of organic semiconductor layers and/or organic conductor layers for use in PLEDs in Appl. Phys. Lett. 2001, 78(24), 3905-3907.
Micro-contact printing: this method is described for example for the production of organic semiconductor layers and/or organic conductor layers for use in PLEDs in Polym. Prepr. 1999, 40(2), 1248-1249.

The method according to the invention (drying) consists in the fact that, after the respective layer (wet film) has been deposited, the action of the radiation commences.

Preferably, this takes place as directly as possible after the deposition of the wet film within 60 seconds, preferably within 30 seconds, particularly preferably within 10 seconds, very particularly preferably within 1 second, above all very particularly preferably within 0.1 sec. In another form of embodiment of the drying method, the drying of the wet film already starts during the coating.

The drying according to the invention can be carried out as follows: after the deposition of the layer, the coated substrate is placed beneath a radiator. In a special embodiment of the drying, the radiator is integrated into the coating device, so that the drying can be commenced already during the coating. This radiator is characterised by the fact that radiation with wavelengths in the range from 700 nm to 1500 nm is emitted.

Incoherent radiation sources or coherent radiation sources can be used as the radiation source. As incoherent radiation sources, use can be made for example of quicksilver lamps, halogen lamps, gas-discharge lamps or xenon lamps. Such radiation sources are described for example in Lehrbuch der Experimentalphysik, Vol. III: Optik, published by H. Gobrecht, 1987, 8^{th} edition (Walter de Gruyter). Gas lasers, semiconductor lasers or solid-state lasers can be used as coherent radiation sources. Such radiation sources are described for example in Laser, J. Eichler and H. J. Eichler, 1991 (Springer Verlag).

The radiation sources preferably have a housing, which is transparent in the near infrared and in the infrared, but blocks radiation in the visible and UV region. The power thereby absorbed in the lamp housing can be conducted away by suitable cooling. The radiation sources are also characterised in that the power densities described above can be achieved with an adequate life of the radiation source.

Preference is given to the use of halogen lamps with power densities of over 75 kW/m², particularly preferably of 150 kW/m², above all preferably with over 300 kW/m². Preference is also given to the use of suitable reflectors, which permit the whole coated area of the substrate to be irradiated as extensively and as homogeneously as possible. Such radiation sources and reflectors are described for example in German utility model specifications DE 20020148 and DE 20020319. In a special embodiment of the drying method, reflectors that focus the radiation may also be preferred.

Since radiation in the visible region and UV region damages organic materials (see example 2), preference is also given to the use of a device for filtering the visible and/or the ultraviolet wavelength range of the radiation source. This filtering can take place by means of an absorbing medium or a medium exhibiting interference.

Also suitable as radiation sources are IR or NIR lasers, which emit radiation in the wavelength range from 700 nm to 1500 nm, focused or non-focused, for the drying of thin layers. The lasers can be operated either pulsed or in the continuous operation. Furthermore, the lasers can be operated focused or non-focused. By means of diffusers, extensive arrangements of lasers can also be used for extensive drying. An advantage with the use of lasers lies in the fact that no further filters need to be used for filtering of the UV and visible wavelength range. Furthermore, very high power-densities can be achieved by the focusing of the laser beam. The use of a focused beam is especially advantageous with printing techniques such as inkjet for example, since the freshly deposited drops can each be dried with the focused IR laser directly after the printing, whilst the remaining coating of the substrate is still in progress.

In a further form of embodiment, an individual printed area, for example an individual pixel, transistor, image element or component, can be dried by one or more laser beams of suitable wavelength. The focus of the laser beam can be somewhat greater than, somewhat smaller than or roughly the same size as the printed area.

As a laser based on semiconductor elements, consideration can be given for example to the models SLD301, SLD302, SLD304, SLD322, SLD323, SLD324, SLD326, SLD327, SLD402 from the producer Sony, the models ASM808-20CS, ASM808-20W2, ASM808-40CS, ASM808-40W2, ASM980-20W2, ASM980-20W2, ASM980-40CS, ASM980-40W2, which can be purchased through ThorLabs (Newton, N.J., USA), and the solid-state lasers pumped by means of laser diodes 581FS302, 581FS303, 581FS301, which can be purchased through Melles Griot (Ottawa, Ontario, Canada). These laser diodes are characterised in that the emitted wavelengths in the continuous operation are generated in the range between 770 nm and 1100 nm with powers of 0.090 W to 40 W. As pulsed lasers, consideration can also be given to lasers of the model series NanoLaser, for example, which can be purchased through Newport (Irvine, Calif., USA). These lasers are distinguished by wavelengths up to 1100 nm at powers of 5 mW and pulse widths of several nanoseconds.

Particularly favourable effects are achieved by the drying method according to the invention when the latter is used for layers deposited from solutions or dispersions containing organic conductors, semiconductors or colour filters, which contain at least one difficultly volatile or high-boiling solvent; high-boiling solvents have as a rule a boiling point of at least 120° C., preferably of more than 150° C.; difficultly volatile solvents have evaporation enthalpies of more than 1000 J/g, preferably more than 1500 J/g.

As described above, layers produced in this way are distinguished in particular by a very good morphology, without being bound to a special theory in the case of this phenomenon, and further favourable properties, such as a reduced inception voltage for electroluminescence, an improved current flow and/or a raised efficiency in Cd/A (further details can be obtained from examples 3-8!).

The present invention will be explained in greater detail with the following examples, there being no intention to restrict it thereto. The expert can derive from the description and the listed examples, without inventive aid, further methods according to the invention for drying organic wet films and can use the latter to obtain organic layers therefrom.

### EXAMPLE 1

### Comparative Example; Film Formation and Device Properties of Polymeric Light-Emitting Diodes (PLEDs) Produced with Solutions of Tetralin with Conventional Drying

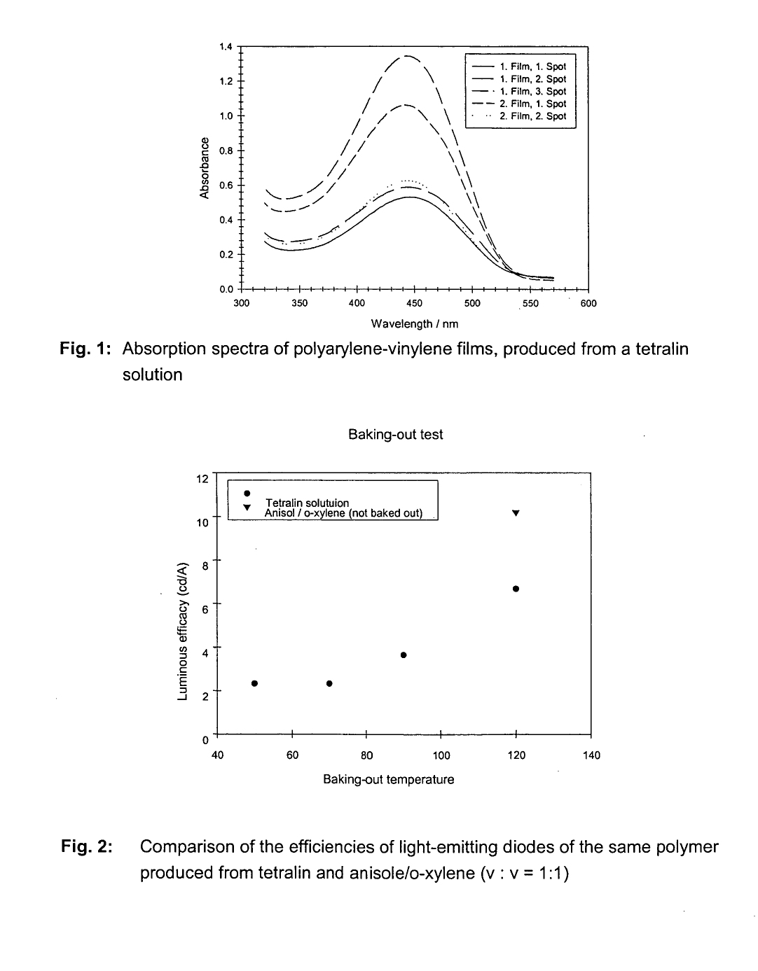

Thin layers of organic semiconductors, which have been deposited by means of spin-coating from tetralin solutions, exhibit great heterogeneity in the layer thickness when dried on a heating plate. Absorption spectra permit the measurement of layer thicknesses using the Lambert-Beer law (E=ε c d). FIG. 1 shows the absorption spectra of two poly-arylene-vinylene films, which have been produced in an identical manner by the spin-coating of a tetralin solution on glass substrates measuring 3×3 cm². The layer thicknesses vary even on one substrate by a factor of 2. In order to obtain homogeneous films, the films would have to be left on the spin-coater for 12 minutes and then be baked-out for 10 minutes at 120° C. This slow drying leads to the difficulties already mentioned for the application in printing processes. Despite the long drying time, the residual content of solvent remained so large that the efficiencies from polymeric light-emitting diodes produced from tetralin did not reach those obtained from anisole/o-xylene (v: v=1:1) (see FIG. 2). Both in terms of the film quality obtained and on account of the long drying time, the use of a heating plate for the drying of films of organic semiconductors, organic conductors or organic colour filters is not therefore preferred.

### EXAMPLE 2

### Comparative Example. Infrared Irradiation of a Photoluminescent Polymer with and without Additional UV Filter

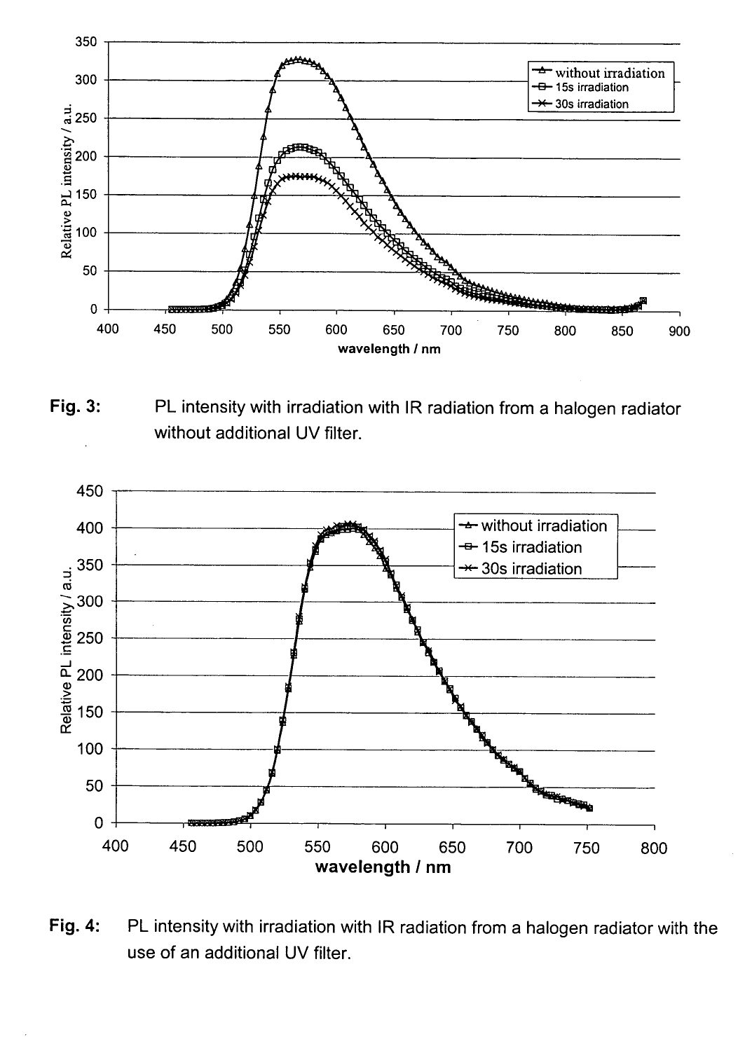

The irradiation of organic photoluminescent materials with UV light leads us a rule to photo-degradation of the material. This photo-degradation makes itself evident in a marked reduction of the PL intensity of the organic material. FIG. 3 shows the PL spectra of polymer material, which has been irradiated with radiation from a halogen lamp without an additional UV filter. The material already shows a marked loss of PL intensity after an irradiation time of 15 s. This loss continues to increase with lengthening of the irradiation time to 30 s.

If a UV filter is used in addition, no degradation of the PL intensity can be ascertained with irradiation times of 30 s and 15 S, as is shown in FIG. 4.

### EXAMPLE 3

### Method for the Production of Test Diodes

In order to characterise the PLEDs, test diodes were produced via spin-coating and not by expensive printing processes. In detail, the procedure was as follows:

The substrates (ITO, approx. 150 nm on glass) were cleaned with a scavenging agent in water by exposure to ultrasound and then further prepared by the action of UV radiation in an ozone plasma.

A thin layer (approx. 20-30 nm) of an organic conductor (PEDOT, commercially available as BAYTRON P™ from BAYER, or Pani, commercially available from Ormecon) was first deposited by spin-coating on the substrates thus prepared. The drying of this layer (drying step 1) took place either by means of a heating plate or by infrared radiation. The substrates were then transferred into a glove-box (exclusion of air!). Here, the layers of light-emitting polymers were then also deposited by spin-coating of the solutions of the respective polymers (layer thickness approx. 60-90 nm). The drying of these layers (drying stage II) took place by means of a heating plate or by infrared radiation.

The cathode was then deposited by thermal evaporation in a high vacuum (<10⁻⁶ mbar). For the results described here, a double cathode consisting of barium (approx. 9 nm) and silver (approx. 100 nm) was used.

The test diodes (PLEDs) thus produced were contacted in the standard manner and examined for their electro-optical characteristics.

### EXAMPLE 4

### Drying of Solutions of Organic Semiconductors in Tetralin. I. Drying After the Coating

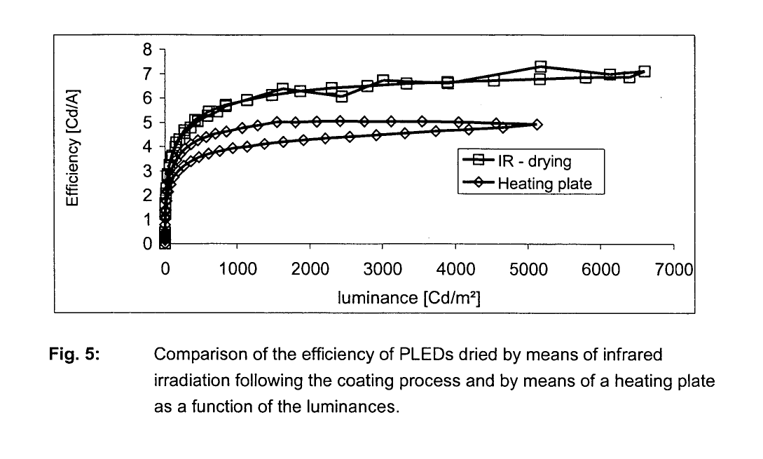

The test diodes (PLEDs) were produced according to example 3. Drying step I for the organic conductor was carried out by means of a heating plate. Solutions of polymeric organic semiconductors in tetralin were spun on the spin-coater for 12 minutes for the coating of the light-emitting polymer and then exposed to infrared radiation for 20 seconds (drying step II). The efficiencies obtained are compared in FIG. 5 with the efficiencies of standard devices, with which drying step II of the polymer films took place on a heating plate for 10 minutes at 120° C. The efficiencies obtained for the PLED dried by infrared radiation lie 30% above those of the PLED dried by means of a heating plate.

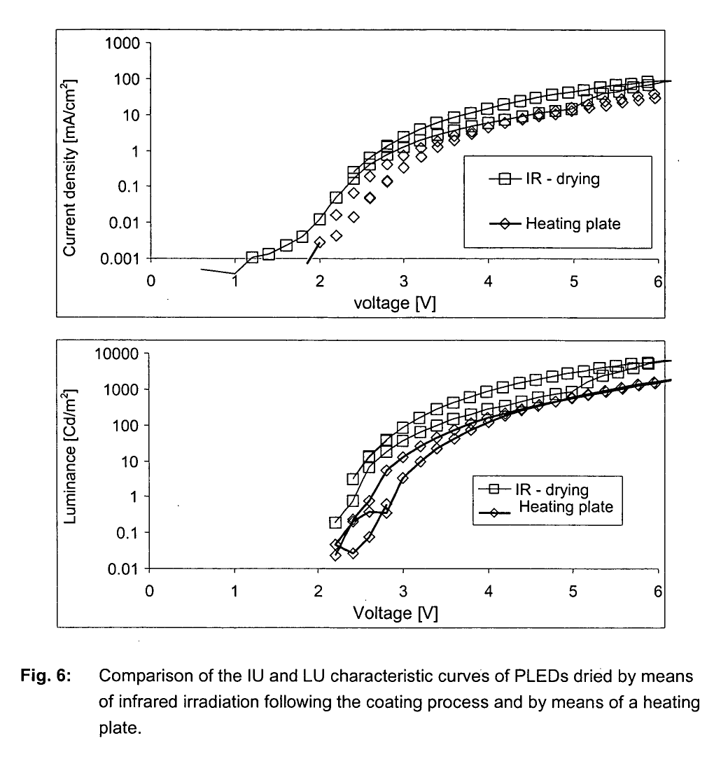

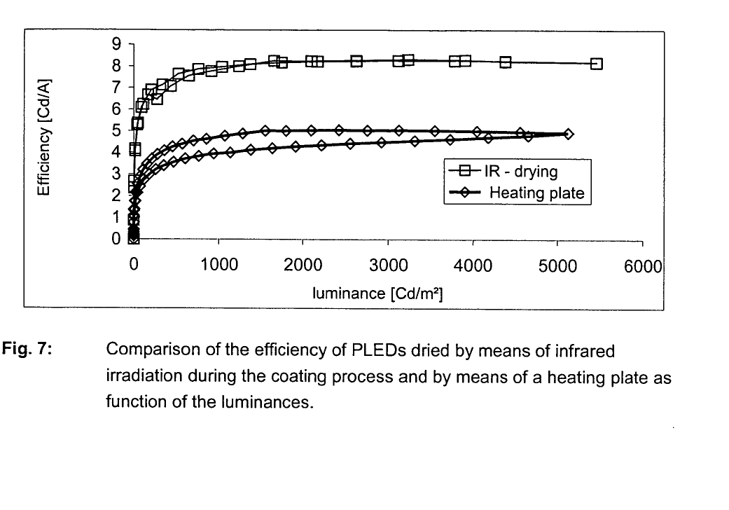

Surprisingly, not only an improvement in the efficiencies is obtained. With the same operating voltage, current densities and luminances of the PLEDs with which drying step II was carried out by means of infrared radiation are increased by a factor of 3 and 6 respectively compared with the PLEDs with which drying step II took place by means of a heating plate, as is shown in FIG. 6.

### EXAMPLE 5

### Drying of Solutions of Organic Semiconductors in Tetralin. II. Drying During the Coating

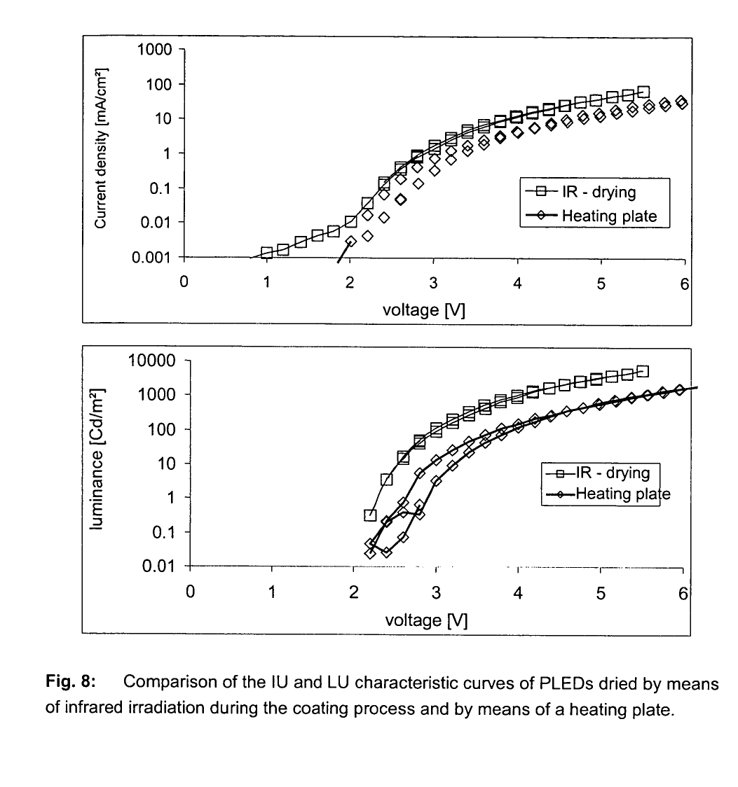

As shown in example 4, the test diode has to remain on the spin-coater for 12 minutes before drying step II in the conventional process, in order to guarantee a homogeneous layer quality. With shorter spin-coating times of less than 12 minutes, films exhibiting great heterogeneity of the layer thickness are obtained when use is made of tetralin as a solvent and when drying is by means of a heating plate. An improvement in process times with improved layer homogeneities and device efficiencies can be achieved by the method described below. Surprisingly, the coating process in combination with infrared irradiation can be shortened enormously, whereby after application of the polymer solution the substrate rotates for several seconds on the spin-coater and then the drying by means of infrared radiation starts while the coating process is still going on (drying step II in example 3 already begins during the coating). Films with improved morphology are thus obtained, without being bound to a special theory in the case of this phenomenon. FIG. 7 shows the efficiencies obtained compared with a test device with which drying step II has been carried out by 10 minutes on the heating plate at 120° C. after 12 minutes spin-coating. As can be seen, markedly improved values are obtained with infrared irradiation that is already taking place during the coating. Surprisingly, a marked improvement in the characteristic curves is also obtained by the infrared irradiation, as shown in FIG. 8. With equal voltage, the obtained current densities and luminances of the infrared-irradiated PLED are a factor of 3 and 6 respectively above those of the PLED dried by means of a heating plate.

### EXAMPLE 6

### Drying of Water-Based Dispersions/Solutions

I. PEDOT

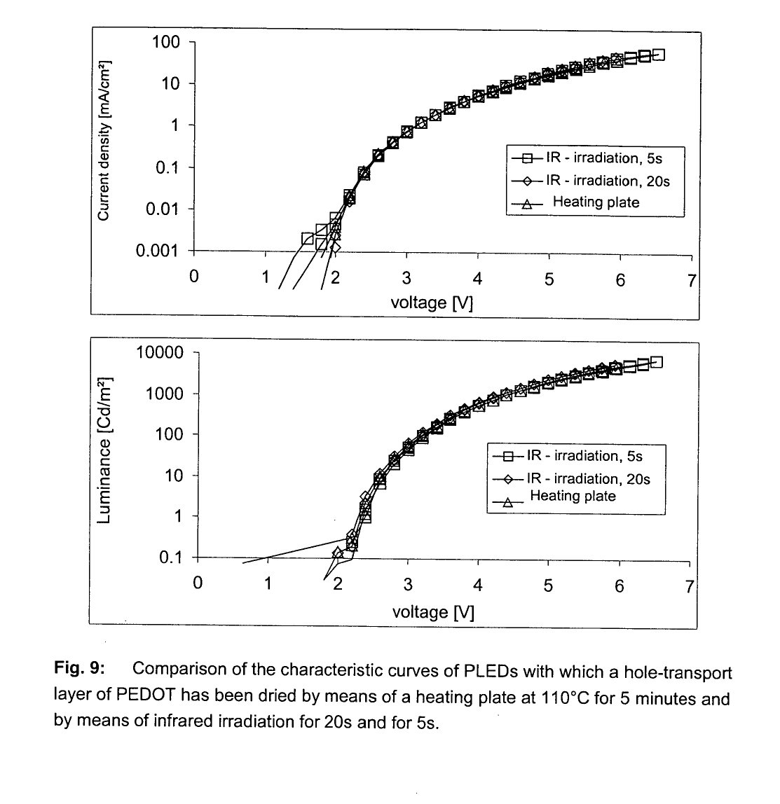

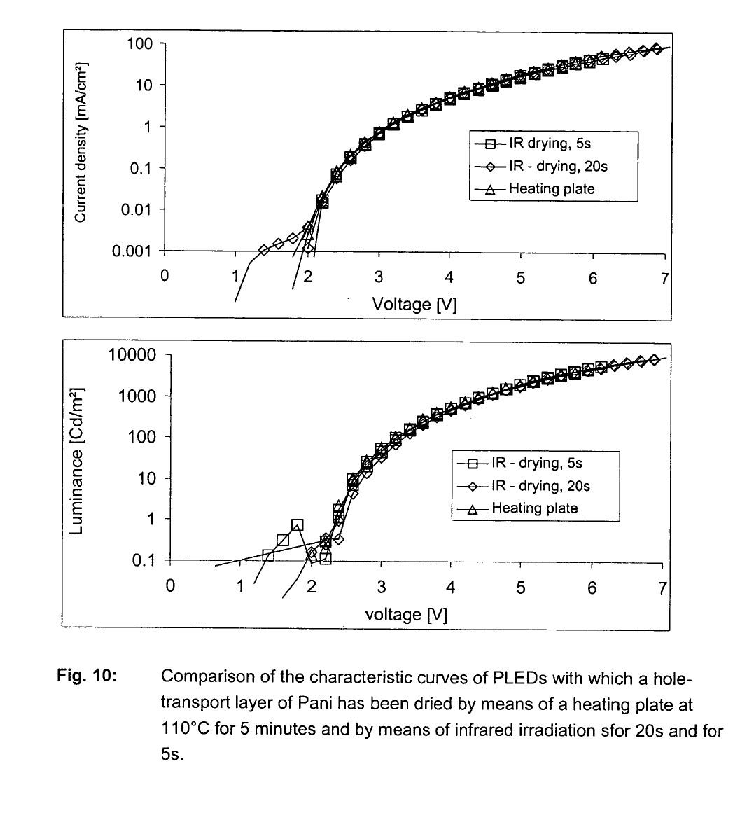

PEDOT films (commercially available as BAYTRON P™ from BAYER) were irradiated with infrared radiation following the spin-coating to carry out drying step I (according to example 3). The efficiencies of the PLEDs obtained therefrom according to example 3 are identical to those of PLEDs with which drying step I of the PEDOT layer took place by means of a heating plate. The process times with the use of infrared radiation, however, are significantly shortened. Good results were obtained with irradiation times of 20 s, preferably of 5 s. With the reference components, the PEDOT layer was dried on a heating plate at 110° C. for 5 minutes. The characteristic curves of the PLEDs are shown in FIG. 9.

### EXAMPLE 7

### Drying of Water-Based Dispersions/Solutions

II. Pani

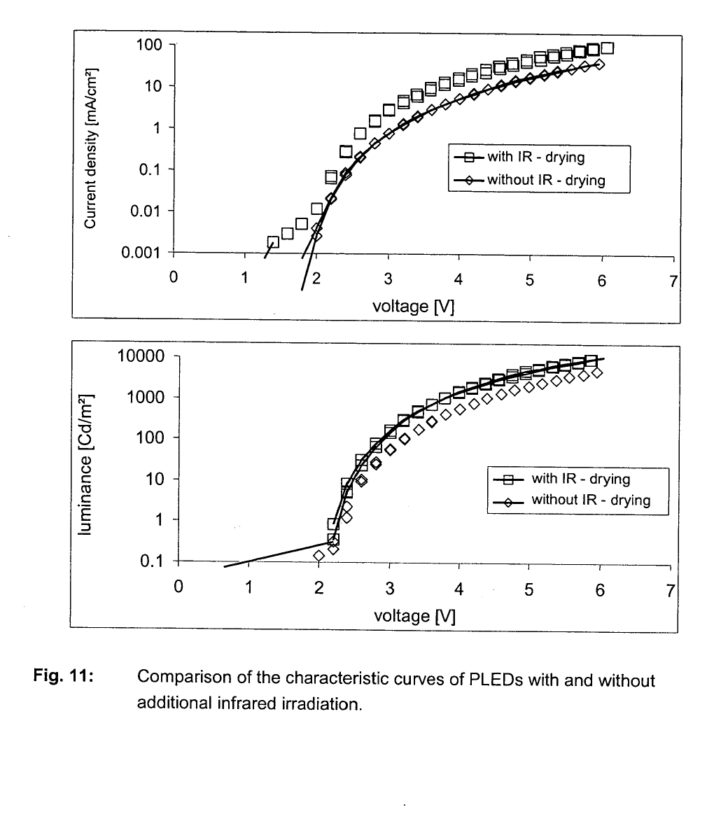

Pani films were irradiated with infrared radiation following the spin-coating to carry out drying step I (according to example 3). The efficiencies of the PLEDs obtained therefrom according to example 3 are identical to those of PLEDs with which drying step I of the Pani layer took place by means of a heating plate. The process times with the use of infrared radiation, however, are significantly shortened. Good results were obtained with irradiation times of 20 s, preferably of 5 s. With the reference components, the Pani layer was dried on a heating plate at 110° C. for 5 minutes. The characteristic curves of the PLEDs are shown in FIG. 10.

### EXAMPLE 8

### Comparison of PLEDs with Which the Organic Layers have been Treated with Infrared Radiation after the Drying

Surprisingly, it was found that the irradiation of PLEDs after drying step II, i.e. after the drying of the conducting organic layer and the layer of the light-emitting polymers of the PLEDs, leads to a considerable improvement in the characteristic curves. Already coated polymer films, with which drying step I and II was carried out by means of a heating plate, were also exposed to IR irradiation after drying step II had been carried out. The test devices obtained from these polymer films are compared in FIG. 11 with test devices which were not subjected to additional IR irradiation after the drying (drying step I & II also by means of a heating plate). An increase in the current densities and the luminances by a factor of 3 and by a factor of 2.5 respectively is found with the same voltage.

### EXAMPLE 9

### Comparison of PLEDs with Which the Electroluminescent organic Layer was Treated with Infrared Irradiation after the Application of the Film

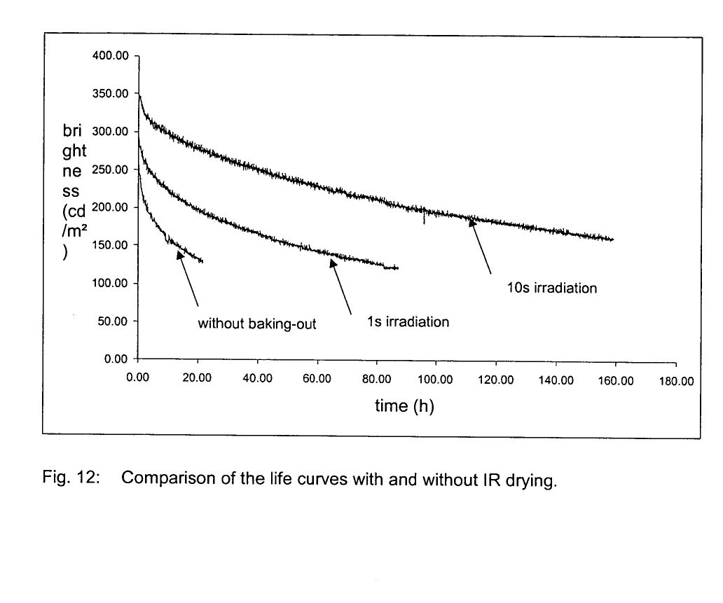

Surprisingly, it was found that the irradiation of PLEDs also has a very favourable effect on their life. FIG. 12 shows a comparison of the life curves of a light-emitting polymer without and with 1 s and 10 s IR drying respectively. The life is increased considerably by the drying step.

1. A method for producing thin layers of organic semiconductors, organic conductors or organic color filters comprising the steps:
(a) deposition of solutions or dispersions containing at least one organic semiconductor or organic conductor or organic color filters onto a substrate,
(b) drying of the wet film produced according to step (a) by means of IR and/or NIR radiation,
wherein radiation is used in step (b) with which at least 80% of the radiant energy lies in the range from 700 to 2000 nm.

2. The method according to claim 1, characterised in that the radiant intensity of the radiation used is greater than 75 kW/m².

3. The method according to claim 1, wherein the dried solid film layer contains less than 1% (related to the mass) of solvent.

4. The method according to claim 1, wherein the drying of the wet film takes place in less than 30 seconds.

5. The method according to claim 1, wherein the drying (step b) takes place directly after the coating (step a).

6. The method according to claim 1, wherein characterised in that the drying (step b) is already started during the coating (step a).

7. The method according to claim 1, wherein the solutions or dispersions containing organic conductors, semiconductors or color filters contain at least one high-boiling solvent, whose boiling point amounts to at least 120° C.

8. The method according to claim 1, wherein the solutions or dispersions containing organic conductors, semiconductors or color filters contain at least one volatile solvent, whose vaporization enthalpy amounts to more than 1000 J/g.

9. A method for the aftertreatment of dried layers of organic semiconductors, organic conductors or organic colour filters with IR/NIR radiation, with which at least 80% of the radiant energy lies in the range from 700 to 2000 mm.

10. The method according to claim 9, characterised in that the radiant intensity of the radiation used is greater than 75 kW/m².

11. The method according to claim 9, wherein the dried solid film layer contains, prior to the aftertreatment, a content of more than 1% (related to the mass) of solvent.

12. The method according to claim 9, characterised in that the aftertreated solid film layer contains less than 1% (related to the mass) of solvent.

13. The method according to claim 9, characterised in that duration of the aftertreatment amounts to less than 30 seconds.

14. (canceled)

15. Organic light-emitting diodes (PLEDs), organic integrated circuits (O-ICs), organic field-effect transistors (OFETs), organic thin-film transistors (OTFTs), organic solar cells (O-SCs), organic laser diodes (O-lasers), organic color filters for liquid crystal displays or organic photoreceptors which are made by the process of claim 1.
